(19) United States
(12) Patent Application Publication
(10) Pub. No.: US 2001/0005836 A1
(43) Pub. Date: Jun. 28, 2001

(54) Running exerciser structure

(76) Inventor: Chia-Feng Yang, Chia-Li Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/737,746

(22) Filed: Dec. 18, 2000

(30) Foreign Application Priority Data
Dec. 21, 1999 (TW) 88221960

(51) Int. Cl. G06F 17/60

(52) U.S. Cl. 705/38

(57) ABSTRACT

The present invention is an improved system for providing a single source system for efficiently managing the collection, tracking, reporting, and fund remittance functions of debt recovery activity between credit grantors and collection agencies. The system is provided with a central server that is networked with various credit grantor and collection agency-operated interfaces to provide improved efficiency and monitoring of the collection process. The server is programmed to format and “scrub” incoming accounts from credit grantors prior to “scoring” the same on proprietary scoring models. This allows the server to select the most appropriate collection agency for each particular account. Once the agency works the file and collects funds from the debtor, the funds are routed through the system to the credit grantor. Throughout the collection process credit grantors and collection agencies are able to monitor, audit, and update the status of each account.

### BACKGROUND OF THE INVENTION

1. Field of the Invention

The present invention relates to the field of accounts receivable management, and more particularly to a method for providing an on-line accounts receivable management system for managing the collection, tracking, reporting, and fund remittance functions of debt recovery activity between credit grantors and collection agencies.

2. Description of the Related Art

The credit granting industry is currently experiencing a number of challenges. Many of the industry sectors have gone through, or are going through, massive consolidation. This consolidation has lead to the difficult challenge of trying to combine back office functions (receivable management), the struggle to find the economies of scale and savings that most consolidations are predicated on, and trying to determine which vendors to retain and which vendors to eliminate. Other industries, such as energy and utilities are being deregulated. This, along with the surge in e-businesses in these industries, is creating the need for enhanced infrastructure and methods of outsourcing.

Another challenge faced by the credit granting industry is increased competition. Increased competition has one sobering effect on any market, a dissipating margin. As margins decrease, the outstanding revenue in a company's receivable portfolio becomes more relevant. Sometimes the margin reaches delinquency levels. Therefore, managing this area while maximizing liquidity is paramount.

Expense Management is yet another challenge faced by credit grantors today. Senior management and boards of directors are waging an all out war on efficiency. Companies are issuing strict directives to outsource, eliminate, and re-engineer all overhead and internal processes in order to decrease expense and increase efficiency. As managers struggle to find ways to do more with less they are looking for solutions that maintain quality and results but lower cost.

These factors demonstrate an industry need for an outsourcing opportunity with the economic leverage of the Internet, intelligent decision support tools to maximize liquidation, and an aggregation strategy to bring the best providers and buyers together in a seamless fashion with one common interface. Such an outsourcing opportunity should also eliminate the need for internal OCA management departments, thereby removing the expense associated with maintaining such departments and ultimately enhancing return and cash acceleration.

Currently, credit grantors are forced to manage many individual collection agencies through the collection process. This requires multiple contact points and interfaces to run efficiently, thereby generating significant costs. By outsourcing all of these functions through a single credit manager, however, credit grantors can simplify their agency selection and management, increase net return on portfolios, and improve cash flow. Clearly, a single source for managing the collection, tracking, reporting, and fund remittance functions of debt recovery activity between credit grantors and collection agencies is needed.

Collection agencies are also facing challenges within the industry. Although “scoring technology” models have been developed, small to mid-sized agencies have been denied access to these models, based on their cost. A system of credit management is needed that will provide these agencies with affordable access to such collection scoring models.

A consolidated client base of credit grantors makes acquisition of clients more expensive for collection agencies. As fewer credit grantors exist, competition among agencies for their debt portfolios increases, making it much more difficult for an agency to acquire new client listings. The result is higher sales costs with slimmer margins for collection agencies. Additionally, former “large” agencies have merged to become behemoths, making it increasingly difficult for the more nimble and capable mid-sized agency to gain access and compete with the mega-agency. Experts in the art have commented that the quality of service and results were better before consolidation. Additionally, the experts have expressed that pricing was more reflective of value before the consolidators and roll-ups appeared. As a result, credit grantors need improved access to the nimble service-oriented collection agency to obtain optimal pricing and collection results based on factual and objective performance monitoring.

Collection agencies are further burdened with the requirement to maintain multiple client-specific technological interfaces because of the variety of systems used by the several credit grantors they represent. This customization of client interfaces requires significant computer programming and development expense on the part of the collection agency. Such interfaces are necessary because they allow the agency to provide reporting data to the credit grantor, as well as receive account listings and other necessary data transmissions. To reduce the programming costs associated with maintaining them such systems, a single credit management system that eliminates the need for multiple client-specific technological interfaces is needed.

Therefore, there is a need for an improved method for providing a single source system for efficiently managing the collection, tracking, reporting, and fund remittance functions of debt recovery activity between credit grantors and collection agencies.

### SUMMARY OF THE INVENTION

The present business method, or “Global Debt Network”, is implemented by an “account manager”, who manages the several functions of debt recovery activity between credit grantors and collection agencies. First, the account manager contracts with a credit grantor to manage its past due accounts receivable portfolios. After selecting accounts for outsource recovery treatment, the credit grantor refers the portfolio to the Global Debt Network's centralized database via the Internet and the designed system interface.

After receiving designated accounts from the credit grantor, the accounts may be “scrubbed” prior to placement, through links between the Global Debt Network and information appending vendors that verify debtor addresses, phone numbers, and any other missing account information, or additional information that may enhance the recoverability of the account.

The Global Debt Network then subjects each account to its proprietary collections scoring models, Placement Optimization™ and Liquidity Scoring and Prioritization Intelligence™. The first model, Placement Optimization™, segments the portfolios according to scoring criteria, which is then used to decide which member agencies will receive the most recoverable portfolios based on their agency's expertise. The model will reflect such criteria as past agency performance, agency capacity, language capabilities, consumer location, account balance, age, compliance record, audit credibility records, U.C.C. filings searches, etc. The second scoring model, Liquidity Scoring and Prioritization Intelligence™ will provide “collectibility” scores to assist network agencies in identifying accounts with the highest likelihood of recovery. This feature provides smaller agencies access to the benefits of scoring technology that previously may have been unattainable.

The Global Debt Network method further provides a constant “champion-challenger” environment between member agencies. Based on the scoring model, Global Debt Network will list accounts with the highest performing agencies in order to maximize return and improve cash flow for the credit grantor. Most portfolios (based on minimum size criteria) will be split between two or more agencies to ensure competitive performance and to verify that agency capability and performance is constantly updated. Only the highest quality collection agencies will pass identified certification criteria and be used as Global Debt Network agencies.

All agency results are captured and updated daily in the Global Debt Network database. This information is available in real time to the credit grantors via their Internet connection and client access security over the Global Debt Network site. Credit grantors will be able to review portfolio specific and aggregated performance results on all of their accounts. Credit grantors can also view the placement criteria and see where Global Debt Network has placed the business. Periodic reports, in monthly, weekly, and year-to-date formats are also made available to the credit grantor as well as account status, batch track, spin downs, cancel and return, pending, and other customized reports.

Collected funds are remitted daily from the network agency to Global Debt Network. Global Debt Network then credits the appropriate accounts and generates electronic remittances, funds transfer reports, and transactions directly to the credit grantor systems and accounts.

Thus, a primary objective of the invention is to provide an improved method for efficiently managing the collection, tracking, reporting, and fund remittance functions of debt recovery activity between credit grantors and collection agencies.

Another objective of the invention is to provide a single source system for managing the collection, tracking, reporting, and fund remittance functions of debt recovery activity between credit grantors and collection agencies.

Another objective of the invention is to provide a method for managing debt recovery activity between credit grantors and collection agencies that maximizes liquidity.

Another objective of the invention is to provide a method for managing debt recovery activity between credit grantors and collection agencies that utilizes the speed and convenience of the Internet.

Another objective of the invention is to provide an outsourcing opportunity that eliminates the need for internal OCA management departments, thereby removing the expense associated with maintaining such departments and ultimately enhancing return and cash acceleration.

Another objective of the invention is to provide a system of credit management that provides collection agencies with affordable access to collection scoring models.

Another objective of the invention is to provide a system of credit management that provides credit grantors with improved access to efficient, service-oriented collection agencies.

Another objective of the invention is to provide a single credit management system that eliminates the need for multiple client-specific technological interfaces.

These and other objects will be apparent to those skilled in the art.

### BRIEF DESCRIPTION OF THE DRAWINGS

FIG. 1 shows a diagram of a computer system for managing the debt recovery activity between credit grantors and collection agencies; and

FIG. 2 shows a further detailed diagram of the computer system for managing the debt recovery activity between credit grantors and collection agencies.

### DESCRIPTION OF THE PREFERRED EMBODIMENT

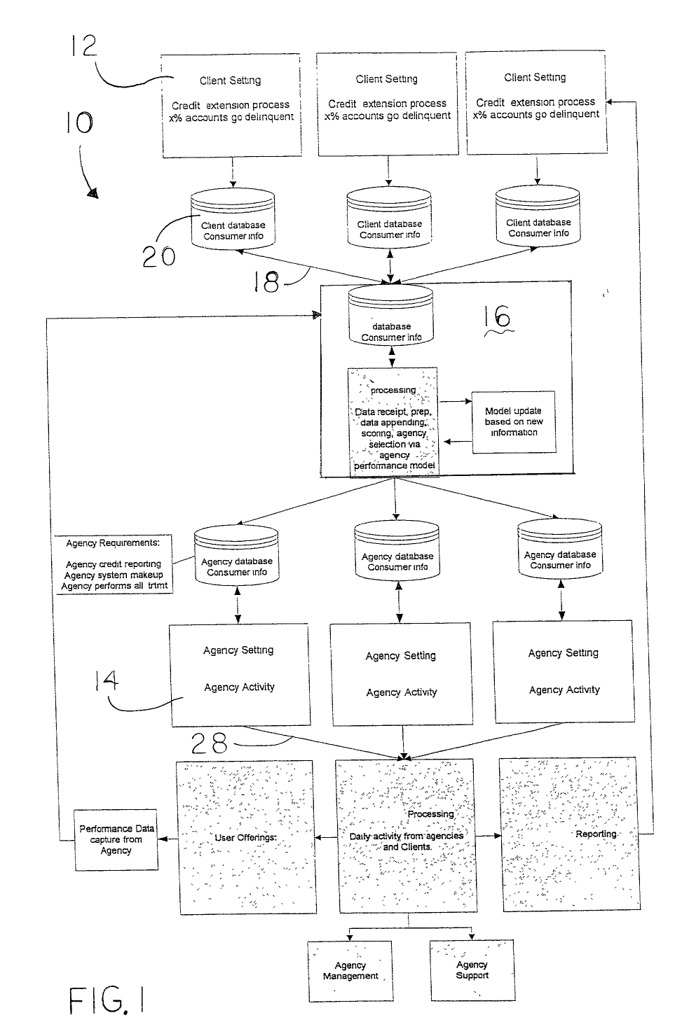

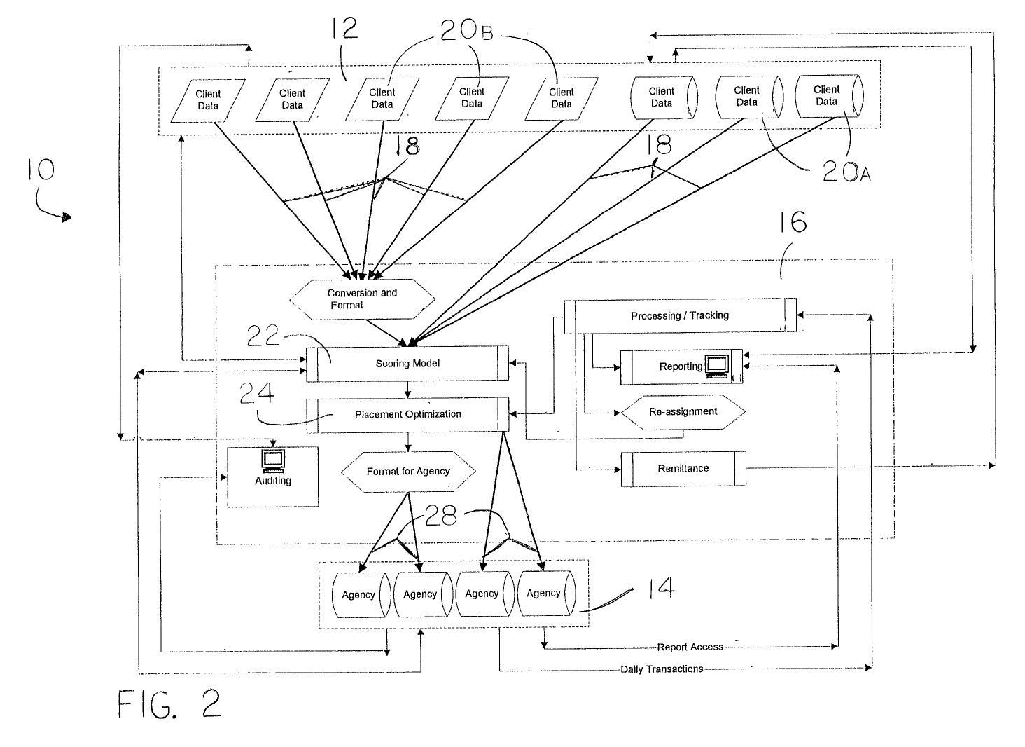

The present method and system, as shown in FIGS. 1 and 2, is an improved single source system 10 for efficiently managing the collection, tracking, reporting, and fund remittance functions of debt recovery activity between at least one credit grantor 12 and at least one collection agency 14. The system 10 is provided with a credit grantor-operated interface having at least an input device and a display device, and a server 16 having at least a processor and a data storage device. A network connection 18 is provided between the credit grantor-operated interface and the server 16. One embodiment of such a connection is an Internet connection via the World Wide Web and a DDS (Direct Dial Service) between the credit grantor-operated interface and the server 16. It is contemplated that many other types of network connections could be used, such as a radio frequency communication with a local auxiliary service center, CATV adapter (sprucer) connected through a local CATV service center, or direct network connections.

Once a credit grantor 12 has selected certain accounts for outsource recovery treatment, the credit grantor 12 transmits the account information data 20 to the Global Debt Network server 16 via the network connection 18. It is contemplated that account information data 20 will come to the server 16 in two forms. First, the account information data may come to the server 16 in a format that is comprised of complete account and debtor information and is further presented in a format that is usable by the server 16 (represented by 20a in FIG. 2). Second, the information may come to the server 16 having incomplete account data and/or otherwise properly formatted for use by the server 16 (represented by 20b in FIG. 2). In the first instance, the server 16 will direct the account data information 20a directly to the scoring model 22 to be analyzed. In the later case, the account information 20b data would be “scrubbed.” In the first step of the scrubbing process, accounts having missing data, such as debtor addresses, phone numbers, etc., are reviewed and appended by third-party vendors specializing in the acquisition of debtor information. It is contemplated that the third party vendor could either receive the account information data in paper form, or preferably through a network connection similar to network connection 18. After the account information data has been appended, it is then formatted by the server 16 to conform to the operating system used by the server 16. Once formatted, the account data can be scored and the server 16 will direct the account data information directly to the scoring model.

The server 16 uses two collections scoring models, Placement Optimization™ and Liquidity Scoring and Prioritization Intelligence™. The first model, Placement Optimization™, segments the portfolios according to scoring criteria, which is then used to decide which member agencies will receive the most recoverable portfolios based on their agency's expertise. The model will reflect such criteria as past agency performance, agency capacity, language capabilities, consumer location, account balance, age, compliance record, audit credibility records, U.C.C. filings searches, etc. The second scoring model, Liquidity Scoring and Prioritization Intelligence™ will provide collectibility scores to assist network agencies in identifying accounts with the highest likelihood of recovery.

Once the account information has been scored, the server 16 directs the accounts to the placement optimization model 24, which determines the appropriate collection agency 14 to direct the account to for collection. The server 16 maintains a database of collection agencies 14 that is continuously updated as to the identity and performance parameters of the collection agencies listed therein. Based on the scoring model, the server 16 will list accounts with the highest performing agencies in order to maximize return and improve cash flow for the credit grantor 12. Most portfolios (based on minimum size criteria) will be split between two or more agencies to ensure competitive performance and to verify that agency capability and performance is constantly updated. Only the highest quality collection agencies 14 will pass identified certification criteria and be used as network collection agencies by the server 16. This comparison placement system will greatly enhance the success rate of the collection process, by providing a continuous “champion-challenger” environment between the member collection agencies 14.

Prior to sending the account information data 20 to the selected collection agency 14, the account information data 20 is reformatted by the server 16 (represented by 26 in FIG. 2) to conform to the particular operating system used by the collection agency-operated interface. The collection agency-operated interface is provided with at least input device and a display device. Once the account information data is reformatted, it is transmitted by the server 16 to the collection agency-operated interface via a network connection 28 similar to the network connection 18.

Once the account information data 20 is received, the accounts are worked by the collection agency 14 according to the agency's usual collection practices. All collection results are captured and updated daily in the server 16 through communications between the collection agency-operated interface and the server 16 via the network connection 28. This information is made available by the server 16 in real-time to the credit grantors 12 via the network connection 18. Credit grantors 12 are also able to review portfolio specific and aggregated performance results on all of their accounts. Credit grantors 12 can further view the placement criteria and see where the Global Debt Network server 16 has placed the accounts for collection. Periodic reports, in monthly, weekly, and year-to-date formats are also made available by the server 16 to the credit grantor as well as account status, batch track, spin downs, cancel and return, pending, and other customized reports.

Once funds are collected by the collection agency 14, the funds are remitted on a daily basis from the collection agency 14 to the server 16. The server 16 then credits the appropriate accounts and generates electronic remittances, funds transfer reports, and transactions directly to the credit grantor systems and accounts.

In the drawings and in the specification, there has been set forth a preferred embodiment of the invention and although specific items are employed, these are used in a generic and descriptive sense only and not for purposes of limitation. Changes in the form and proportion of parts, as well as in the substitution of equivalents, are contemplated as circumstances may suggest or render expedient without departing from the spirit or scope of the invention as further defined in the following claims.

Thus it can be seen that the invention accomplishes at least all of its stated objectives.

We claim:

1. A method for managing debt recovery activity between at least one credit grantor and at least one collection agency, provided with a credit grantor-operated interface having at least an input device and a display device, a server having at least a processor and a data storage device, and a network for connecting said credit grantor-operated interface to said server, comprising the steps of:
establishing a network connection between said credit grantor-operated interface and said server;
transmitting account information data from said credit grantor-operated interface to said server;
transmitting said account information data from said server to a collection agency;
receiving collected funds from said collection agency; and
transferring said collected funds to said credit grantor.

2. The method of claim 1, further comprising the step of appending any missing data after said account information data is received from said credit grantor-operated interface.

3. The method of claim 2, further comprising the step of formatting said account information data after said account information data is appended.

4. The method of claim 3, further comprising the step of scoring said account information data after said account information data is formatted.

5. The method of claim 4, further comprising the step of converting said account information data to a collection agency format prior to transmitting said account information data to said collection agency.

6. The method of claim 5, further comprising the step of providing auditing information to said collection agency and said credit grantor.

7. The method of claim 6, further comprising the step of providing on-line reporting to said collection agency and said credit grantor.

8. The method of claim 7, further comprising the step of receiving periodic transactions from said collection agency.

9. The method of claim 8, further comprising the step of processing said periodic transactions received from said collection agency.

10. The method of claim 9, further comprising the step of reporting said periodic transactions in a reporting system.

11. The method of claim 10, further comprising the step of making said reporting system available to said credit grantor.

12. The method of claim 11, further comprising the step of identifying transactions meeting selected requirements for re-assignment.

13. The method of claim 12, further comprising the step of scoring said transactions identified as meeting selected requirements for re-assignment.

14. The method of claim 13, further comprising the step of updating the criteria used to score said transactions and said account information data.

15. The method of claim 14, further comprising the step of processing periodic transactions for remittance.

16. A system for, managing the debt recovery activity between at least one credit grantor and at least one collection agency comprising:
at least one credit grantor-operated interface having at least an input device and a display device;
a server having at least a processor and a data storage device; and
a network for connecting said credit grantor-operated interface to said server; said server processor being programmed to:
a) receive account information data from said credit grantor-operated interface; and
b) transmit said account information data from said server to a collection agency.

17. The system of claim 16 wherein said server processor is further programmed to receive data, appending any missing data after said account information data is received from said credit grantor-operated interface.

18. The system of claim 17 wherein said server processor is further programmed to format said account information data after said account information data is appended.

19. The system of claim 18 wherein said server processor is further programmed to score said account information data after said account information data is formatted.

20. The system of claim 19 wherein said server processor is further programmed to convert said account information data to a collection agency format prior to transmitting said account information data to said collection agency.

21. The system of claim 20 wherein said server processor is further programmed to provide auditing information to said collection agency and said credit grantor.

22. The system of claim 21 wherein said server processor is further programmed to provide on-line reporting to said collection agency and said credit grantor.

23. The system of claim 22 wherein said server processor is further programmed to receive periodic transactions from said collection agency.

24. The system of claim 23 wherein said server processor is further programmed to process said periodic transactions received from said collection agency.

25. The system of claim 24 wherein said server processor is further programmed to report said periodic transactions in a reporting system.

26. The system of claim 25 wherein said server processor is further programmed to make said reporting system available to said credit grantor.

27. The system of claim 26 wherein said server processor is further programmed to identify transactions meeting selected requirements for re-assignment.

28. The system of claim 27 wherein said server processor is further programmed to score said transactions identified as meeting selected requirements for re-assignment.

29. The system of claim 28 wherein said server processor is further programmed to update the criteria used to score said transactions and said account information data.

30. The system of claim 29 wherein said server processor is further programmed to process periodic transactions for remittance.
